(19) United States
(12) Patent Application Publication
(10) Pub. No.: US 2024/0379930 A1
(43) Pub. Date: Nov. 14, 2024

(54) RIBBED ELECTRODE DISPENSATION NOZZLES, AND METHODS OF PRODUCING THE SAME

(71) Applicant: 24M Technologies, Inc., Cambridge, MA (US)

(72) Inventors: Neil AXELSEN, Watertown, MA (US); Jason SAINDON, Somerville, MA (US)

(21) Appl. No.: 18/649,698

(22) Filed: Apr. 29, 2024

Related U.S. Application Data
(60) Provisional application No. 63/465,113, filed on May 9, 2023.

(51) Int. Cl. H01M 4/04; B05C 5/02

(52) U.S. Cl. CPC H01M 4/0404; B05C 5/0245; H01M 4/0419

(57) ABSTRACT

Embodiments described herein relate to dispensation of semi-solid electrode material. In some aspects a method of forming an electrode ribbon can include dispensing an entry stream of semi-solid electrode material into a nozzle, while the entry stream is in the nozzle, dividing the entry stream into a first substream and a second substream, while the first substream and the second substream are in the nozzle, rejoining the first substream and the second substream to form a rejoined stream, dispensing the rejoined stream out of the nozzle onto a current collector via an orifice to form an electrode ribbon. In some embodiments, the dividing can be via a rib disposed along an interior surface of the nozzle. In some embodiments, the entry stream can be divided into a first substream, a second substream, and a third substream.

### CROSS-REFERENCE TO RELATED APPLICATIONS

The present application claims priority to and the benefit of U.S. Provisional Application No. 63/465,113, filed May 9, 2023, and entitled “Ribbed Electrode Dispensation Nozzles, and Methods of Producing the Same,” the entire disclosure of which is incorporated herein by reference.

### TECHNICAL FIELD

Embodiments described herein relate to dispensation of semi-solid electrode material.

### BACKGROUND

Semi-solid electrodes have useful properties in construction of electrochemical cells. They can be used to maximize usable electrochemical energy per unit volume. They are often dispensed from cartridges via nozzles onto current collectors moving along a conveyor device. This dispensation can occur at high speeds, such that the expulsion of the semi-solid electrode material produces a high force. The high force can cause deflection of the nozzle, either parallel or perpendicular to the direction of dispensation. This deflection can cause uneven mass and volume distribution of the semi-solid electrode material along the length of the dispensed semi-solid electrode. Limiting or properly distributing the force imparted on the nozzle can reduce deflection.

### SUMMARY

Embodiments described herein relate to dispensation of semi-solid electrode material.

In some aspects a method of forming an electrode ribbon can include dispensing an entry stream of semi-solid electrode material into a nozzle, while the entry stream is in the nozzle, dividing the entry stream into a first substream and a second substream, while the first substream and the second substream are in the nozzle, rejoining the first substream and the second substream to form a rejoined stream, and dispensing the rejoined stream out of the nozzle onto a current collector via an orifice to form an electrode ribbon. In some embodiments, the dividing can be via a rib disposed along an interior surface of the nozzle. In some embodiments, the entry stream can be divided into a first substream, a second substream, and a third substream.

In some embodiments, an apparatus includes: a nozzle having a void volume, the void volume having a substantially rectangular cross section and a plurality of inner walls; and a rib disposed in the void volume and contacting at least two inner walls of the plurality of inner walls, the rib having a proximal terminal end having a first width, a distal terminal end having a second width, and a central section having a third width, the third width larger than the first width or the second width.

In some embodiments, an apparatus includes: a nozzle including a void volume, the void volume defining: a plenum portion configured to receive a first flow of a semi-solid electrode material, a splitting portion downstream of the plenum portion, the splitting portion including a plurality of ribs coupled to at least two inner surface of the nozzles to define a plurality of channels configured to divide the first flow into a plurality of second flows, a combining portion downstream of the splitting portion, the combining portion configured to combine the plurality of second flows to generate a third flow of the semi-solid material, and a distal orifice a distal orifice downstream of the combining portion, the distal orifice configured to dispense the third flow, wherein the splitting portion is configured to inhibit deflection of the nozzle during flow of the semi-solid electrode material through the void volume.

### BRIEF DESCRIPTION OF THE DRAWINGS

FIG. 1 is a flow diagram of a method of forming an electrode ribbon, according to an embodiment.

FIG. 2 is a block diagram of a dispensation device, according to an embodiment.

FIGS. 3A-3B are illustrations of a ribbed nozzle, according to an embodiment.

FIGS. 4A-4B are illustrations of a ribbed nozzle, according to an embodiment.

FIGS. 5A-5B are illustrations of a ribbed nozzle, according to an embodiment.

FIG. 6 is an illustration of a rib, according to an embodiment.

FIG. 7 is an illustration of a collection of ribs, according to an embodiment.

FIG. 8 is an illustration of a collection of ribs, according to an embodiment.

FIG. 9 is an illustration of a collection of ribs, according to an embodiment.

FIG. 10 is an illustration of a collection of ribs, according to an embodiment.

FIGS. 11A-11C are illustrations of a ribbed nozzle, according to an embodiment.

FIG. 12 is an illustration of a ribbed nozzle, according to an embodiment.

FIGS. 13A-13B are photographs of a test nozzle for dispensing semi-solid electrode material for development of the rib parameters.

### DETAILED DESCRIPTION

Embodiments described relate to dispensation of semi-solid electrodes. Semi-solid electrodes cause the nozzle to deflect when dispensed under normal dispensation pressures. An anti-deflection rib design can prevent such deflections in a rectangular flow path or other flow path to allow dispensation of larger electrodes, which can conform to meet customer cell requirements. Anti-deflection ribs can physically connect two large internal faces of a rectangular flow path, preventing each wall from deflecting outwards under high target dispensation pressures. This physical connection between the ribs and the internal faces of the rectangular flow path can allow a semi-solid electrode to pass by the ribs and dispensed without introducing additional defects to the semi-solid electrode material.

Electrodes described herein include semi-solid electrodes. Semi-solid electrodes described herein can be made: (i) thicker (e.g., greater than 100 μm—up to 2,000 μm or even greater) than conventional electrodes due to the reduced tortuosity and higher electrical conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the semi-solid electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

In some embodiments, the semi-solid electrode material can be pressurized via a piston. In some embodiments, the semi-solid electrode material can flow through and out of the nozzles described herein and onto current collectors or lengths of current collector material. The breadth of dispensation nozzles increases with increasing electrode size and dispensation throughput. The number of ribs included in the flow path of the semi-solid electrode material can depend on the width of the nozzle flow path. In some embodiments, the ribs can be fastened to interior walls of the nozzle. The fastening can prevent the nozzle from deflecting open under casting pressures, which can result in non-conforming parts and damage to equipment.

In some embodiments, dispensation methods described herein can include aspects of the dispensation methods described in U.S. Patent Publication No. 2022/0115710 (“the '710 publication”), filed Oct. 12, 2021, and titled, “Methods of Continuous and Semi-Continuous Production of Electrochemical Cells,” the disclosure of which is hereby incorporated by reference in its entirety. In some embodiments, dispensation methods described herein can include aspects of the dispensation methods described in U.S. Pat. No. 11,139,467 (“the '467 patent”), filed Jul. 9, 2019, and titled, “Continuous and Semi-Continuous Methods of Semi-Solid Electrode and Battery Manufacturing,” the disclosure of which is hereby incorporated by reference in its entirety. In some embodiments, dispensation methods described herein can include aspects of the dispensation methods described in U.S. patent application Ser. No. 18/133,671 (“the '671 application”), filed Apr. 12, 2023, and titled, “Continuous and Semi-Continuous Methods of Electrode and Electrochemical Cell Manufacturing,” the disclosure of which is hereby incorporated by reference in its entirety.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

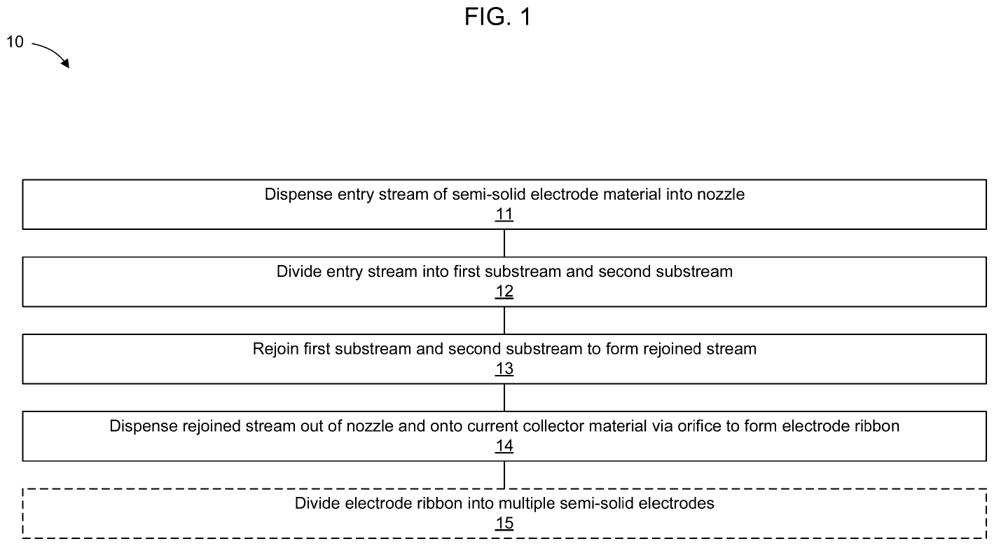

FIG. 1 is a flow diagram of a method 10 of forming an electrode ribbon, according to an embodiment. As shown, the method 10 includes dispensing an entry stream of a semi-solid electrode material into a nozzle at step 11, dividing the entry stream into a first substream and a second substream at step 12, rejoining the first substream and the second substream to form a rejoined stream at step 13, and dispensing the rejoined stream out of the nozzle and onto a current collector material via an orifice to form an electrode ribbon at step 14. The method 10 optionally includes dividing the electrode ribbon into multiple semi-solid electrodes.

Step 11 includes dispensing the entry stream of semi-solid electrode material into a nozzle. In some embodiments, the nozzle can have a proximal end (or a leading end) and a distal end (or a trailing end). The semi-solid electrode material enters the nozzle via the proximal end and exits the nozzle via the distal end. In some embodiments, step 11 can include dispensing the entry stream of semi-solid electrode material into the nozzle from a cartridge.

In some embodiments, the semi-solid electrode material can include a semi-solid anode material. In some embodiments, the semi-solid anode material can include graphite, lithium metal (Li), sodium metal (Na), silicon oxide (SiO), graphite, silicon, carbon, lithium-intercalated carbon, lithium nitrides, lithium alloys, lithium alloy forming compounds, or any other anode active material, inclusive of all combinations thereof. In some embodiments, the lithium alloy forming compounds can include silicon, bismuth, boron, gallium, indium, zinc, tin, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon carbide, and/or silicon-graphite composite. In some embodiments, the semi-solid electrode material can include a semi-solid cathode material. In some embodiments, the semi-solid cathode material can include lithium cobalt oxide (LCO), lithium nickel manganese cobalt oxide (NMC), lithium iron phosphate (LFP), or any other cathode active material, inclusive of all combinations thereof.

In some embodiments, the composition of the semi-solid electrode material can include about 30% to about 85% by volume of an active material. In some embodiments the composition of the semi-solid electrode material can include about 50% to about 85% by volume, or 60% to about 85% by volume of an active material. In some embodiments, the composition of the semi-solid electrode material can include at least about 30%, at least about 35%, at least about 40%, at least about 45%, at least about 50%, at least about 55%, at least about 60%, at least about 65%, at least about 70%, at least about 75%, or at least about 80% by volume of an active material. In some embodiments, the composition of the semi-solid electrode material can include no more than about 85%, no more than about 80%, no more than about 75%, no more than about 70%, no more than about 65%, no more than about 60%, no more than about 55%, no more than about 50%, no more than about 45%, no more than about 40%, or no more than about 35% by volume of an active material. Combinations of the above-referenced volume percentages of active material in the composition of the semi-solid electrode material are also possible (e.g., at least about 30% by volume and no more than about 85% by volume or at least about 40% by volume and no more than about 70% by volume), inclusive of all values and ranges therebetween. In some embodiments, the composition of the semi-solid electrode material can include about 30%, about 35%, about 40%, about 45%, about 50%, about 55%, about 60%, about 65%, about 70%, about 75%, about 80%, or about 85% by volume of an active material.

In some embodiments, the composition of the semi-solid electrode material can include about 0.5% to about 30% by volume of a conductive material. In some embodiments, the composition of the semi-solid electrode material can include about 1.0% to about 6% by volume of a conductive material. In some embodiments, the composition of the semi-solid electrode material can include at least about 0.5%, at least about 1%, at least about 1.5%, at least about 2%, at least about 2.5%, at least about 3%, at least about 3.5%, at least about 4%, at least about 4.5%, at least about 5%, at least about 5.5%, at least about 6%, at least about 6.5%, at least about 7%, at least about 7.5%, at least about 8%, at least about 8.5%, at least about 9%, at least about 9.5%, at least about 10%, at least about 15%, at least about 20%, or at least about 25% by volume of a conductive material. In some embodiments, the composition of the semi-solid electrode material can include no more than about 30%, no more than about 25%, no more than about 20%, no more than about 15%, no more than about 10%, no more than about 9.5%, no more than about 9%, no more than about 8.5%, no more than about 8%, no more than about 7.5%, no more than about 7%, no more than about 6.5%, no more than about 6%, no more than about 5.5%, no more than about 5%, no more than about 4.5%, no more than about 4%, no more than about 3.5%, no more than about 3%, no more than about 2.5%, no more than about 2%, no more than about 1.5%, or no more than about 1% by volume of a conductive material. Combinations of the above-referenced volume percentages of conductive material in the composition of the semi-solid electrode material are also possible (e.g., at least about 0.5% by volume and no more than about 30% by volume or at least about 5% by volume and no more than about 10% by volume), inclusive of all values and ranges therebetween. In some embodiments, the composition of the semi-solid electrode material can include about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 15%, about 20%, about 25%, or about 30% by volume of a conductive material.

In some embodiments, the composition of the semi-solid electrode material can include about 15% to about 60% by volume of a liquid electrolyte. In some embodiments, the composition of the semi-solid electrode material can include about 20% to about 40%, or about 10% to about 30% by volume of a liquid electrolyte. In some embodiments, the composition of the semi-solid electrode material can include at least about 15%, at least about 20%, at least about 25%, at least about 30%, at least about 35%, at least about 40%, at least about 45%, at least about 50%, or at least about 55% by volume of an electrolyte. In some embodiments, the composition of the semi-solid electrode material can be no more than about 60%, no more than about 55%, no more than about 50%, no more than about 45%, no more than about 40%, no more than about 35%, no more than about 30%, no more than about 25%, or no more than about 20% by volume of a liquid electrolyte. Combinations of the above-referenced volume percentages of liquid electrolyte in the composition of the semi-solid electrode material are also possible (e.g., at least about 15% and no more than about 60% or at least about 20% and no more than about 40%), inclusive of all values and ranges therebetween. In some embodiments, the composition of the semi-solid electrode material can include about 15%, about 20%, about 25%, about 30%, about 35%, about 40%, about 45%, about 50%, about 55%, or about 60% by volume of a liquid electrolyte. The stream of semi-solid electrode material entering the nozzle can include a single, cohesive stream of material.

In some embodiments, the dispensation of the entry stream into the nozzle can be from a cartridge. In some embodiments, the dispensation into the nozzle can be at a pressure of at least about 3,000 KPa (gauge), at least about 3,500 kPa, at least about 4,000 kPa, at least about 4,500 kPa, at least about 5,000 kPa, at least about 5,500 kPa, at least about 6,000 kPa, at least about 6,500 kPa, at least about 7,000 kPa, at least about 7,500 kPa, at least about 8,000 kPa, at least about 8,500 kPa, at least about 9,000 kPa, or at least about 9,500 kPa. In some embodiments, the dispensation into the nozzle can be at a pressure of no more than about 10,000 kPa, no more than about 9,500 kPa, no more than about 9,000 kPa, no more than about 8,500 kPa, no more than about 8,000 kPa, no more than about 7,500 kPa, no more than about 7,000 kPa, no more than about 6,500 kPa, no more than about 6,000 kPa, no more than about 5,500 kPa, no more than about 5,000 kPa, no more than about 4,500 kPa, no more than about 4,000 kPa, or no more than about 3,500 kPa.

In some embodiments, the semi-solid electrode material can move through the nozzle at a throughput of at least about 1 g/min, at least about 2 g/min, at least about 3 g/min, at least about 4 g/min, at least about 5 g/min, at least about 6 g/min, at least about 7 g/min, at least about 8 g/min, at least about 9 g/min, at least about 10 g/min, at least about 20 g/min, at least about 30 g/min, at least about 40 g/min, at least about 50 g/min, at least about 60 g/min, at least about 70 g/min, at least about 80 g/min, at least about 90 g/min, at least about 100 g/min, at least about 200 g/min, at least about 300 g/min, at least about 400 g/min, at least about 500 g/min, at least about 600 g/min, at least about 700 g/min, at least about 800 g/min, at least about 900 g/min, at least about 1 kg/min, at least about 2 kg/min, at least about 3 kg/min, at least about 4 kg/min, at least about 5 kg/min, at least about 6 kg/min, at least about 7 kg/min, at least about 8 kg/min, at least about 9 kg/min, at least about 10 kg/min, at least about 20 kg/min, at least about 30 kg/min, at least about 40 kg/min, at least about 50 kg/min, at least about 60 kg/min, at least about 70 kg/min, at least about 80 kg/min, at least about 90 kg/min, at least about 100 kg/min, at least about 200 kg/min, at least about 300 kg/min, at least about 400 kg/min, at least about 500 kg/min, at least about 600 kg/min, at least about 700 kg/min, at least about 800 kg/min, or at least about 900 kg/min. In some embodiments, the semi-solid electrode material can move through the nozzle at a throughput of no more than about 1,000 kg/min, no more than about 900 kg/min, no more than about 800 kg/min, no more than about 700 kg/min, no more than about 600 kg/min, no more than about 500 kg/min, no more than about 400 kg/min, no more than about 300 kg/min, no more than about 200 kg/min, no more than about 100 kg/min, no more than about 90 kg/min, no more than about 80 kg/min, no more than about 70 kg/min, no more than about 60 kg/min, no more than about 50 kg/min, no more than about 40 kg/min, no more than about 30 kg/min, no more than about 20 kg/min, no more than about 10 kg/min, no more than about 9 kg/min, no more than about 8 kg/min, no more than about 7 kg/min, no more than about 6 kg/min, no more than about 5 kg/min, no more than about 4 kg/min, no more than about 3 kg/min, no more than about 2 kg/min, no more than about 1 kg/min, no more than about 900 g/min, no more than about 800 g/min, no more than about 700 g/min, no more than about 600 g/min, no more than about 500 g/min, no more than about 400 g/min, no more than about 300 g/min, no more than about 200 g/min, no more than about 100 g/min, no more than about 90 g/min, no more than about 80 g/min, no more than about 70 g/min, no more than about 60 g/min, no more than about 50 g/min, no more than about 40 g/min, no more than about 30 g/min, no more than about 20 g/min, no more than about 10 g/min, no more than about 9 g/min, no more than about 8 g/min, no more than about 7 g/min, no more than about 6 g/min, no more than about 5 g/min, no more than about 4 g/min, no more than about 3 g/min, or no more than about 2 g/min. Combinations of the above-referenced throughputs are also possible (e.g., at least about 1 g/min and no more than about 1,000 kg/min or at least about 50 g/min and no more than about 5 kg/min), inclusive of all values and ranges therebetween. In some embodiments, the semi-solid electrode material can move through the nozzle at a throughput of about 1 g/min, about 2 g/min, about 3 g/min, about 4 g/min, about 5 g/min, about 6 g/min, about 7 g/min, about 8 g/min, about 9 g/min, about 10 g/min, about 20 g/min, about 30 g/min, about 40 g/min, about 50 g/min, about 60 g/min, about 70 g/min, about 80 g/min, about 90 g/min, about 100 g/min, about 200 g/min, about 300 g/min, about 400 g/min, about 500 g/min, about 600 g/min, about 700 g/min, about 800 g/min, about 900 g/min, about 1 kg/min, about 2 kg/min, about 3 kg/min, about 4 kg/min, about 5 kg/min, about 6 kg/min, about 7 kg/min, about 8 kg/min, about 9 kg/min, about 10 kg/min, about 20 kg/min, about 30 kg/min, about 40 kg/min, about 50 kg/min, about 60 kg/min, about 70 kg/min, about 80 kg/min, about 90 kg/min, about 100 kg/min, about 200 kg/min, about 300 kg/min, about 400 kg/min, about 500 kg/min, about 600 kg/min, about 700 kg/min, about 800 kg/min, about 900 kg/min, or about 1,000 kg/min.

Step 12 includes dividing the entry stream of semi-solid electrode material into a first substream and a second substream. The dividing of the entry stream is via a rib. The rib is connected to the inner walls of the nozzle. In some embodiments, step 12 can include dividing the entry stream into about 2, about 3, about 4, about 5, about 6, about 7, about 8, about 9, about 10, about 20, about 30, about 40, about 50, about 60, about 70, about 80, about 90, or about 100 substreams, inclusive of all values and ranges therebetween.

Step 13 includes rejoining the first substream and the second substream of the semi-solid electrode material to form a rejoined stream of semi-solid electrode material. In some embodiments, step 13 includes rejoining additional substreams (i.e., about 3, about 4, about 5, about 6, about 7, about 8, about 9, about 10, about 20, about 30, about 40, about 50, about 60, about 70, about 80, about 90, or about 100 substreams, inclusive of all values and ranges therebetween). In some embodiments, the high pressure exerted onto the semi-solid electrode material (e.g., via a piston) can cause the substreams to remain compact or flush with the rib or ribs in the nozzle. Once the substreams flow past the distal end of the rib(s), they rejoin due to the high pressure. Step 14 includes dispensing the rejoined stream of electrode material out of the nozzle and onto a current collector material via an orifice. The orifice is positioned at the distal end of the nozzle. In some embodiments, the nozzle can be positioned vertically, such that the electrode material is dispensed downward from the nozzle onto the current collector. In some embodiments, the current collector can be conveyed horizontally as the semi-solid electrode material is dispensed downward onto the current collector material. The semi-solid electrode material and the current collector material can form an electrode ribbon. In some embodiments, the dispensation can form discrete sections of electrode material along the length of the current collector material.

Step 15 is optional and includes dividing the electrode ribbon into multiple semi-solid electrodes. In some embodiments, the division can be via ultrasonication, laser ablation, doctor blade, irradiation, high-precision cutting, or combinations thereof. In some embodiments, the semi-solid electrode material can be separated into discrete portions of the current collector material by speeding up the current collector material at some distance past the nozzle, causing an uncoated portion of current collector material to form between each discrete portion of semi-solid electrode material.

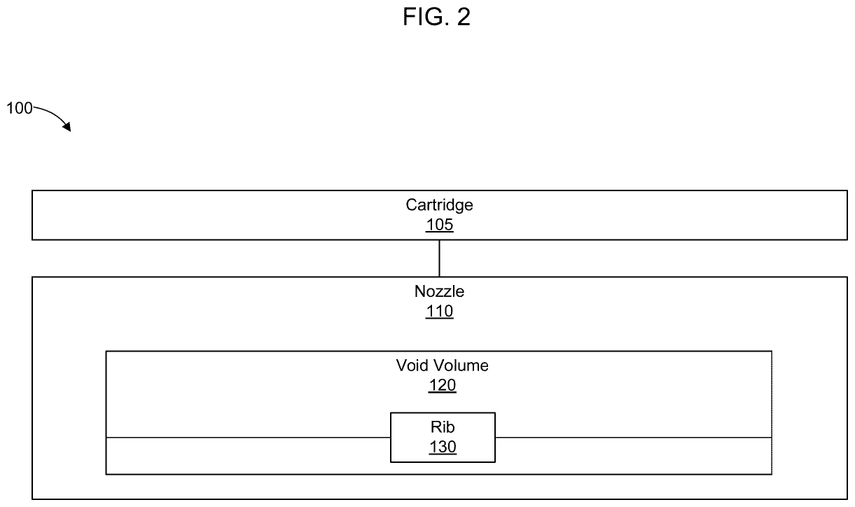

FIG. 2 is a block diagram of a dispensation device 100, according to an embodiment. As shown, the dispensation device 100 includes a cartridge 105, and a nozzle 110. The nozzle 110 includes a void volume 120 and a rib 130 disposed in the void volume 120. The nozzle 110 includes interior walls contacted by the rib 130.

The cartridge 105 houses semi-solid electrode material. In some embodiments, the cartridge 105 can have any of the properties of the cartridges in the '467 patent. The nozzle 110 is coupled to the cartridge 105 and includes an orifice for dispensation of a semi-solid electrode material. The cartridge 105 is used to transport semi-solid electrode material from production rooms to the nozzle 110. Semi-solid electrode material is pushed through and out of the cartridge 105 and through the nozzle 110 during dispensation. The void volume 120 is encompassed by inner walls of the nozzle 110. In some embodiments, the void volume 120 can have a rectangular shape, a square shape, a rectangular shape with rounded corners, a square shape with rounded corners, a circular shape, an oval shape, an elliptical shape, or any other suitable shape for dispensation of semi-solid electrode material. In some embodiments, the nozzle 110 can be composed of a metal (e.g., aluminum, steel, stainless steel, 304 stainless steel, 316 stainless steel, or any combination thereof). In some embodiments, the nozzle 110 can be composed of a polymer (e.g., polyethylene, polystyrene, polypropylene, or any combination thereof).

The rib 130 divides the flow of the semi-solid electrode material. The semi-solid electrode material divides into multiple streams at the proximal end of the rib 130 and the multiple streams rejoin to form a unified stream at the distal end of the rib 130. In some embodiments, the rib 130 can have a sharp proximal tip and a sharp distal tip. The rib 130 is coupled to one or more of the inner walls of the void volume 120. In some embodiments, the rib 130 can be coupled to the inner walls of the void volume 120 via one or more fasteners. In some embodiments, the rib 130 can be coupled to the inner walls of the void volume 120 via welding. In some embodiments, the rib 130 can be coupled to the inner walls of the void volume 120 via machining the rib 130 on the nozzle 120. In some embodiments, the machining can be via electrical discharge machining (EDM). In some embodiments, the rib 130 can be coupled to the inner walls of the void volume 120 via an adhesive.

In some embodiments, the dispensation device 100 can include multiple ribs 130. In some embodiments, the dispensation device 100 can include about 1, about 2, about 3, about 4, about 5, about 6, about 7, about 8, about 9, about 10, about 20, about 30, about 40, about 50, about 60, about 70, about 80, about 90, or about 100 ribs 130, inclusive of all values and ranges therebetween.

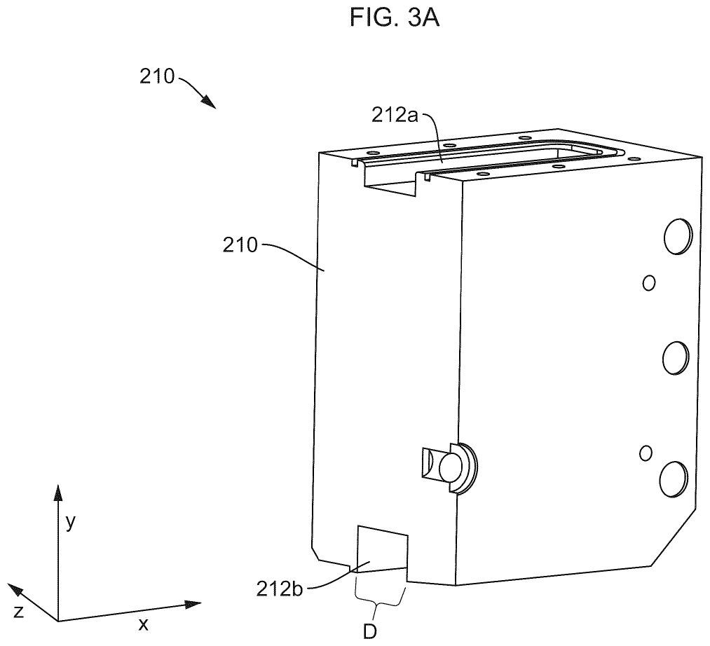

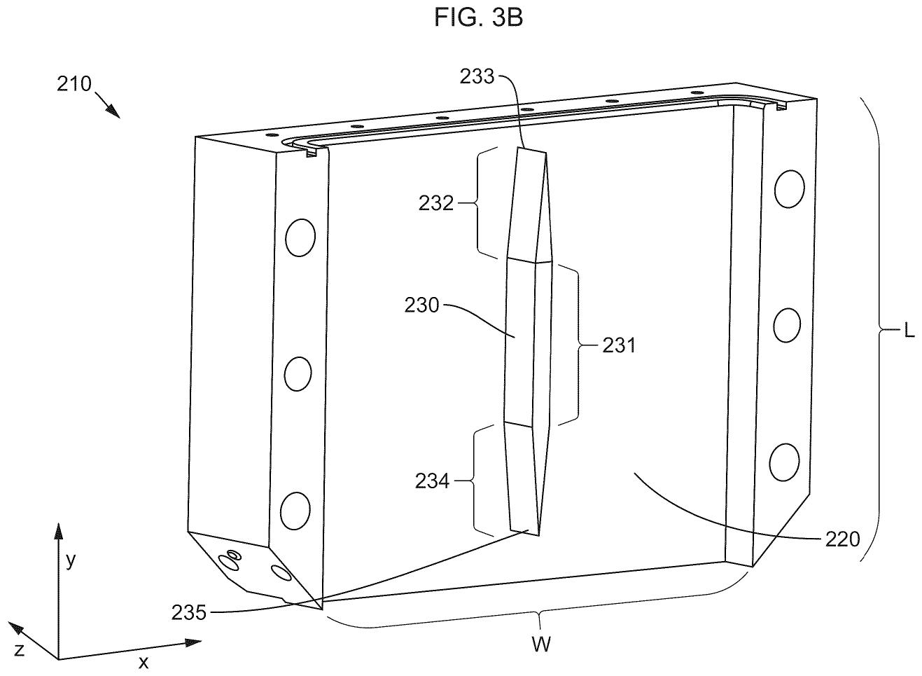

FIGS. 3A-3B are illustrations of a nozzle 210, according to an embodiment. As shown, the nozzle 210 includes a void volume 220 and a rib 230. In some embodiments, the nozzle 210, the void volume 220, and the rib 230 can be the same or substantially similar to the nozzle 110, the void volume 120, and the rib 130, as described above with reference to FIG. 2. Thus, certain aspects of the nozzle 210, the void volume 220, and the rib 230 are not described in greater detail herein. FIG. 3A shows a vertical cross section of the nozzle 210 while FIG. 3B shows a horizontal cross section of the nozzle 210. Axes are shown for structural clarity.

As shown, the nozzle 210 includes a proximal orifice 212a and a distal orifice 212b. Semi-solid electrode material enters the nozzle 210 via the proximal orifice 212a and exits the nozzle 210 via the distal orifice 212b. The proximal orifice 212a and the distal orifice 212b are both openings to the void volume 220. As shown, the void volume 220 includes a length L extending along the y-axis. In some embodiments, the length L can be at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, at least about 1.5 m, at least about 2 m, at least about 2.5 m, at least about 3 m, at least about 3.5 m, at least about 4 m, or at least about 4.5 m. In some embodiments, the length L can be no more than about 5 m, no more than about 4.5 m, no more than about 4 m, no more than about 3.5 m, no more than about 3 m, no more than about 2.5 m, no more than about 2 m, no more than about 1.5 m, no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, or no more than about 2 cm. Combinations of the above-referenced lengths 1 are also possible (e.g., at least about 1 cm and no more than about 5 m or at least about 5 cm and no more than about 20 cm), inclusive of all values and ranges therebetween. In some embodiments, the length L can be about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, about 1 m, about 1.5 m, about 2 m, about 2.5 m, about 3 m, about 3.5 m, about 4 m, about 4.5 m, or about 5 m.

As shown, the void volume 220 includes a width W along the x-axis. In some embodiments, the width W can be at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, or at least about 90 cm. In some embodiments, the width W can be no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, or no more than about 2 cm. Combinations of the above-referenced widths w are also possible (e.g., at least about 1 cm and no more than 1 m or at least about 5 cm and no more than about 50 cm), inclusive of all values and ranges therebetween. In some embodiments, the width W can be about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, or about 1 m.

As shown, the void volume 220 includes a depth D along the z-axis. In some embodiments, the depth D can be at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, at least about 3 cm, at least about 3.5 cm, at least about 4 cm, or at least about 4.5 cm. In some embodiments, the depth D can be no more than about 5 cm, no more than about 4.5 cm, no more than about 4 cm, no more than about 3.5 cm, no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, or no more than about 200 μm. Combinations of the above-referenced depths d are also possible (e.g., at least about 100 μm and no more than about 5 cm or at least about 5 mm and no more than about 2 cm), inclusive of all values and ranges therebetween. In some embodiments, the depth D can be about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 1.5 cm, about 2 cm, about 2.5 cm, about 3 cm, about 3.5 cm, about 4 cm, about 4.5 cm, or about 5 cm.

As shown, the rib 230 includes a central section 231, a proximal section 232 with a proximal tip 233, and a distal section 234 with a distal tip 235. In some embodiments, the central section 231 can have a rectangular cross section. In some embodiments, the central section 231 can be coupled to either of the inner walls of the void volume 220. In some embodiments, the proximal section 232 and/or the distal section 234 can be tapered. In some embodiments, the proximal section 232 and/or the distal section 234 can have a triangular cross section. In some embodiments, the proximal tip 233 and/or the distal tip 235 can be sharp. In some embodiments, the proximal tip 233 and/or the distal tip 235 can be blunt or rounded. In some embodiments, the proximal tip 233 and/or the distal tip 235 can form an angle of about 1 degree, about 2 degrees, about 3 degrees, about 4 degrees, about 5 degrees, about 6 degrees, about 7 degrees, about 8 degrees, about 9 degrees, about 10 degrees, about 20 degrees, about 30 degrees, about 40 degrees, about 50 degrees, about 60 degrees, about 70 degrees, about 80 degrees, about 90 degrees, about 100 degrees, about 110 degrees, about 120 degrees, about 130 degrees, about 140 degrees, about 150 degrees, about 160 degrees, or about 170 degrees, inclusive of all values and ranges therebetween. In some embodiments, the rib 230 can be machined. In some embodiments, the rib 230 can be machined via an EDM process.

In some embodiments, during dispensation, the nozzle 210 can deflect in the y-direction by less than about 30 μm, less than about 29 μm, less than about 28 μm, less than about 27 μm, less than about 26 μm, less than about 25 μm, less than about 24 μm, less than about 23 μm, less than about 22 μm, less than about 21 μm, less than about 20 μm, less than about 19 μm, less than about 18 μm, less than about 17 μm, less than about 16 μm, less than about 15 μm, less than about 14 μm, less than about 13 μm, less than about 12 μm, less than about 11 μm, less than about 10 μm, less than about 9 μm, less than about 8 μm, less than about 7 μm, less than about 6 μm, less than about 5 μm, less than about 4 μm, less than about 3 μm, less than about 2 μm, or less than about 1 μm. In some embodiments, during dispensation, the nozzle 210 can deflect in the x-direction by less than about 30 μm, less than about 29 μm, less than about 28 μm, less than about 27 μm, less than about 26 μm, less than about 25 μm, less than about 24 μm, less than about 23 μm, less than about 22 μm, less than about 21 μm, less than about 20 μm, less than about 19 μm, less than about 18 μm, less than about 17 μm, less than about 16 μm, less than about 15 μm, less than about 14 μm, less than about 13 μm, less than about 12 μm, less than about 11 μm, less than about 10 μm, less than about 9 μm, less than about 8 μm, less than about 7 μm, less than about 6 μm, less than about 5 μm, less than about 4 μm, less than about 3 μm, less than about 2 μm, or less than about 1 μm. In some embodiments, during dispensation, the nozzle 210 can deflect in the z-direction by less than about 30 μm, less than about 29 μm, less than about 28 μm, less than about 27 μm, less than about 26 μm, less than about 25 μm, less than about 24 μm, less than about 23 μm, less than about 22 μm, less than about 21 μm, less than about 20 μm, less than about 19 μm, less than about 18 μm, less than about 17 μm, less than about 16 μm, less than about 15 μm, less than about 14 μm, less than about 13 μm, less than about 12 μm, less than about 11 μm, less than about 10 μm, less than about 9 μm, less than about 8 μm, less than about 7 μm, less than about 6 μm, less than about 5 μm, less than about 4 μm, less than about 3 μm, less than about 2 μm, or less than about 1 μm.

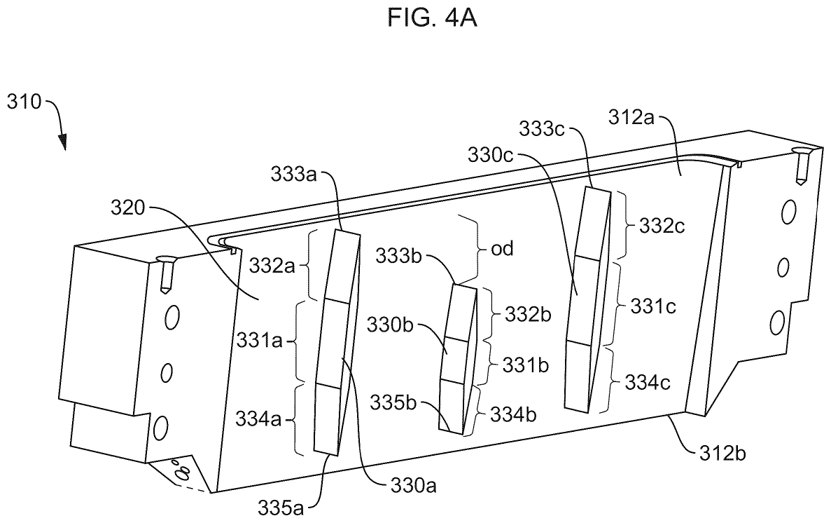

FIGS. 4A-4B are illustrations of a nozzle 310, according to an embodiment. As shown, the nozzle 310 includes a proximal orifice 312a, a distal orifice 312b, a void volume 320, a pressure transducer 321, and ribs 330a, 330b, 330c (collectively referred to as ribs 330). As shown, the ribs 330 include central sections 331a, 331b, 331c (collectively referred to as central sections 331) proximal sections 332a, 332b, 332c (collectively referred to as proximal sections 332), proximal tips 333a, 333b, 333c (collectively referred to as proximal tips 333), distal sections 334a, 334b, 334c (collectively referred to as distal sections 334), and distal tips 335a, 335b, 335c (collectively referred to as distal tips 335). In some embodiments, the proximal orifice 312a, the distal orifice 312b, the void volume 320, the ribs 330, the central section 331, the proximal sections 332, the proximal tips 333, the distal sections 334, and the distal tips 335 can be the same or substantially similar to the proximal orifice 212a, the distal orifice 212b, the void volume 220, the rib 230, the central section 231, the proximal section 232, the proximal tip 233, the distal section 234, and the distal tip 235, as described above with reference to FIGS. 3A-3B. Thus, certain aspects of the proximal orifice 312a, the distal orifice 312b, the void volume 320, the ribs 330, the central section 331, the proximal sections 332, the proximal tips 333, the distal sections 334, and the distal tips 335 are not described in greater detail herein. FIG. 4A shows a front perspective view of a horizontal cross section of the nozzle 310, while FIG. 4B shows a back perspective view of a horizontal cross section of the nozzle 310.

The multiple ribs 330 can add support without changing the external dimensions of the nozzle 310. In some embodiments, the ribs 330 can be machined in place (e.g., via EDM). As shown, the proximal tip 333b is offset from the proximal tip 333a and the proximal tip 333c by an offset distance od. The rib 330b is located distal to the pressure transducer 321 to allow pressure measurements at a location upstream from the splitting of the stream of the semi-solid electrode material. The offset distance od can aid in reducing the pressure in the void volume 320.

In some embodiments, the offset distance od can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 11 cm, at least about 12 cm, at least about 13 cm, at least about 14 cm, at least about 15 cm, at least about 16 cm, at least about 17 cm, at least about 18 cm, or at least about 19 cm. In some embodiments, the offset distance od can be no more than about 20 cm, no more than about 19 cm, no more than about 18 cm, no more than about 17 cm, no more than about 16 cm, no more than about 15 cm, no more than about 14 cm, no more than about 13 cm, no more than about 12 cm, no more than about 11 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced offset distances od are also possible (e.g., at least about 1 mm and no more than about 20 cm or at least about 5 mm and no more than about 5 cm), inclusive of all values and ranges therebetween. In some embodiments, the offset distance od can be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, or about 20 cm.

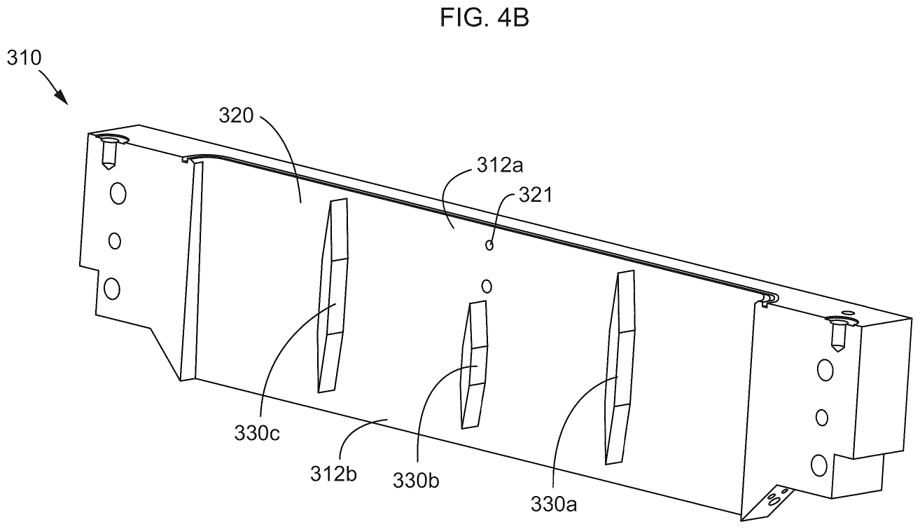

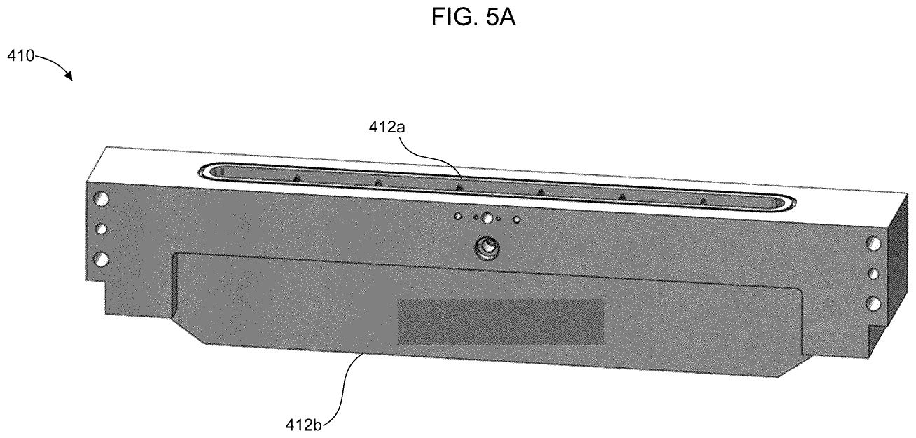

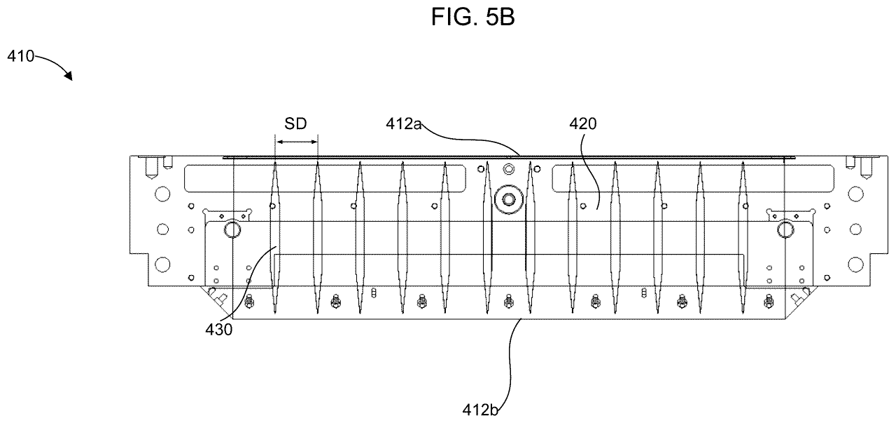

FIGS. 5A-5B are illustrations of a nozzle 410, according to an embodiment. As shown, the nozzle 410 includes a proximal orifice 412a, a distal orifice 412b, a void volume 420, and ribs 430. In some embodiments, the nozzle 410, the proximal orifice 412a, the distal orifice 412b, the void volume 420, and the ribs 430 can be the same or substantially similar to the nozzle 310, the proximal orifice 312a, the distal orifice 312b, the void volume 320, and the ribs 330, as described above with reference to FIGS. 4A-4B. Thus, certain aspects of the nozzle 410, the proximal orifice 412a, the distal orifice 412b, the void volume 420, and the ribs 430 are not described in greater detail herein.

As shown, the ribs 430 are separated by a separation distance SD. The separation distance SD can be measured as a distance from the center of one of the ribs 430 to an adjacent rib 430. In some embodiments, the separation distance SD can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 15 cm, at least about 20 cm, at least about 25 cm, at least about 30 cm, at least about 35 cm, at least about 40 cm, or at least about 45 cm. In some embodiments, the separation distance SD can be no more than about 50 cm, no more than about 45 cm, no more than about 40 cm, no more than about 35 cm, no more than about 30 cm, no more than about 25 cm, no more than about 20 cm, no more than about 15 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced separation distances SD are also possible (e.g., at least about 1 mm and no more than about 50 cm or at least about 5 mm and no more than about 5 cm), inclusive of all values and ranges therebetween. In some embodiments, the separation distance SD can be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 15 cm, about 20 cm, about 25 cm, about 30 cm, about 35 cm, about 40 cm, about 45 cm, or about 50 cm.

In some embodiments, a pressure transducer (not shown) can be disposed in the void volume 420. The pressure transducer can be used to measure the pressure of the semi-solid electrode material while inside the nozzle 410 during dispensation. In some embodiments, the pressure transducer can be in the form of a wire disposed in the void volume 420. In some embodiments, the nozzle 410 can include a blade (not shown) installed thereon to shape and create flat electrodes. In some embodiments, the blade can be an integral component to the body of the nozzle 410. In other words, the blade can be fixed in place. In some embodiments, the blade can be an additional feature on another component of the nozzle 410. In some embodiments, the body of the nozzle 410 can be angled to create flat electrodes. In some embodiments, the blade is a component separate from the nozzle 410 and angled relative to the body of the nozzle 410. In some embodiments, the body of the nozzle 410 contains the ribs 430.

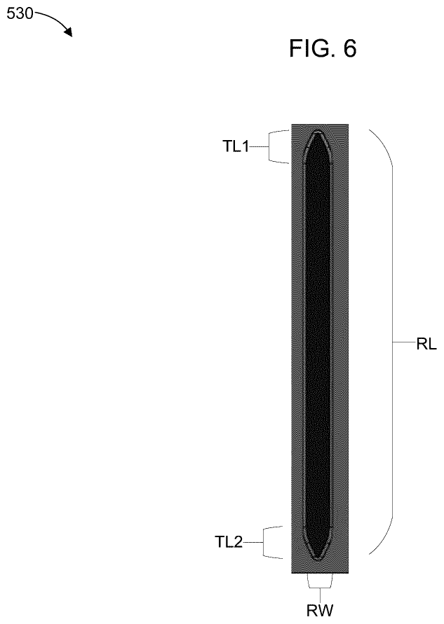

FIG. 6 is an illustration of a rib 530, according to an embodiment. As shown, the rib 530 has tapered sections on either end. The rib 530 has a rib length RL and a rib width RW. The rib length RL extends along the movement path of the semi-solid electrode material. The tapered sections have lengths TL1 and TL2. In some embodiments, the offset distance OD1 and/or the offset distance OD2 can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 11 cm, at least about 12 cm, at least about 13 cm, at least about 14 cm, at least about 15 cm, at least about 16 cm, at least about 17 cm, at least about 18 cm, or at least about 19 cm. In some embodiments, the offset distance OD1 and/or the offset distance OD2 can be no more than about 20 cm, no more than about 19 cm, no more than about 18 cm, no more than about 17 cm, no more than about 16 cm, no more than about 15 cm, no more than about 14 cm, no more than about 13 cm, no more than about 12 cm, no more than about 11 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced distances are also possible (e.g., at least about 1 mm and no more than about 20 cm or at least about 5 mm and no more than about 5 cm), inclusive of all values and ranges therebetween. In some embodiments, the offset distance OD1 and/or the offset distance OD2 can be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, or about 20 cm.

In some embodiments, the rib length RL can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 15 cm, at least about 20 cm, at least about 25 cm, at least about 30 cm, at least about 35 cm, at least about 40 cm, or at least about 45 cm. In some embodiments, the rib length RL can be no more than about 50 cm, no more than about 45 cm, no more than about 40 cm, no more than about 35 cm, no more than about 30 cm, no more than about 25 cm, no more than about 20 cm, no more than about 15 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced rib lengths RL are also possible (e.g., at least about 1 mm and no more than about 50 cm or at least about 5 mm and no more than about 5 cm), inclusive of all values and ranges therebetween. In some embodiments, the rib length RL can be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 15 cm, about 20 cm, about 25 cm, about 30 cm, about 35 cm, about 40 cm, about 45 cm, or about 50 cm.

In some embodiments, the rib width RW can be at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, or at least about 1.5 cm. In some embodiments, the rib width RW can be no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, or no more than about 600 μm. Combinations of the above-referenced rib widths RW are also possible (e.g., at least about 500 μm and no more than about 2 cm or at least about 1 mm and no more than about 1 cm), inclusive of all values and ranges therebetween. In some embodiments, the rib width RW can be about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 1.5 cm, or about 2 cm.

In some embodiments, the tapered length TL 1 and/or the tapered length TL2 can be at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, at least about 3 cm, at least about 3.5 cm, at least about 4 cm, or at least about 4.5 cm. In some embodiments, the tapered length TL1 and/or the tapered length TL2 can be no more than about 5 cm, no more than about 4.5 cm, no more than about 4 cm, no more than about 3.5 cm, no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, or no more than about 600 μm. Combinations of the above-referenced lengths are also possible (e.g., at least about 500 μm and no more than about 5 cm or at least about 5 mm and no more than about 1 cm), inclusive of all values and ranges therebetween. In some embodiments, the tapered length TL1 and/or the tapered length TL2 can be about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 1.5 cm, about 2 cm, about 2.5 cm, about 3 cm, about 3.5 cm, about 4 cm, about 4.5 cm, or about 5 cm.

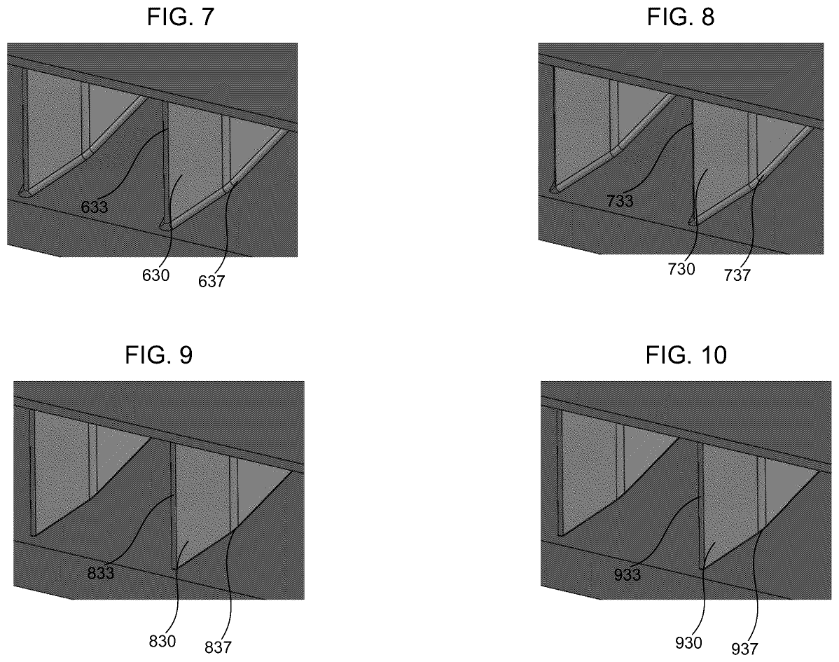

FIGS. 7-10 show tapering and filleting schemes of rib patterns, according to various embodiments. FIG. 7 includes a rib 630 with a tip 633 having a breadth of 500 μm and a fillet 637 having a radius of 1 mm. FIG. 8 includes a rib 730 with a tip 733 having a breadth of 100 μm and a fillet 837 having a radius of 1 mm. FIG. 9 includes a rib 830 with a tip 833 having a breadth of 500 μm and a fillet 837 having a radius of 100 μm. FIG. 10 includes a rib 930 with a tip 933 having a breadth of 100 μm and a fillet 937 having a radius of 100 μm.

In some embodiments, the tip of the rib can have a breadth of at least about 50 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 1.5 mm, at least about 2 mm, at least about 2.5 mm, at least about 3 mm, at least about 3.5 mm, at least about 4 mm, or at least about 4.5 mm. In some embodiments, the tip of the rib can have a breadth of no more than about 5 mm, no more than about 4.5 mm, no more than about 4 mm, no more than about 3.5 mm, no more than about 3 mm, no more than about 2.5 mm, no more than about 2 mm, no more than about 1.5 mm, no more than about 1 mm, no more than about 900 μm, no more than about 800 μm, no more than about 700 μm, or no more than about 600 μm. Combinations of the above-referenced breadths are also possible (e.g., at least about 100 μm and no more than about 5 mm or at least about 500 μm and no more than about 2 mm), inclusive of all values and ranges therebetween. In some embodiments, the tip of the rib can have a breadth of about 50 μm, about 100 μm, about 200 μm, about 300 μm, about 400 μm, about 500 μm, about 600 μm, about 700 μm, about 800 μm, about 900 μm, about 1 mm, about 1.5 mm, about 2 mm, about 2.5 mm, about 3 mm, about 3.5 mm, about 4 mm, about 4.5 mm, or about 5 mm.

In some embodiments, the fillet of the rib can have a radius of at least about 50 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 1.5 mm, at least about 2 mm, at least about 2.5 mm, at least about 3 mm, at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm, at least about 8 mm, at least about 8.5 mm, at least about 9 mm, or at least about 9.5 mm. In some embodiments, the tip of the rib can have a breadth of no more than about 1 cm, no more than about 9.5 mm, no more than about 9 mm, no more than about 8.5 mm, no more than about 8 mm, no more than about 7.5 mm, no more than about 7 mm, no more than about 6.5 mm, no more than about 6 mm, no more than about 5.5 mm, no more than about 5 mm, no more than about 4.5 mm, no more than about 4 mm, no more than about 3.5 mm, no more than about 3 mm, no more than about 2.5 mm, no more than about 2 mm, no more than about 1.5 mm, no more than about 1 mm, no more than about 900 μm, no more than about 800 μm, no more than about 700 μm, or no more than about 600 μm. Combinations of the above-referenced fillet radii are also possible (e.g., at least about 100 μm and no more than about 1 cm or at least about 500 μm and no more than about 5 mm), inclusive of all values and ranges therebetween. In some embodiments, the fillet of the rib can have a radius of about 50 μm, about 100 μm, about 200 μm, about 300 μm, about 400 μm, about 500 μm, about 600 μm, about 700 μm, about 800 μm, about 900 μm, about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

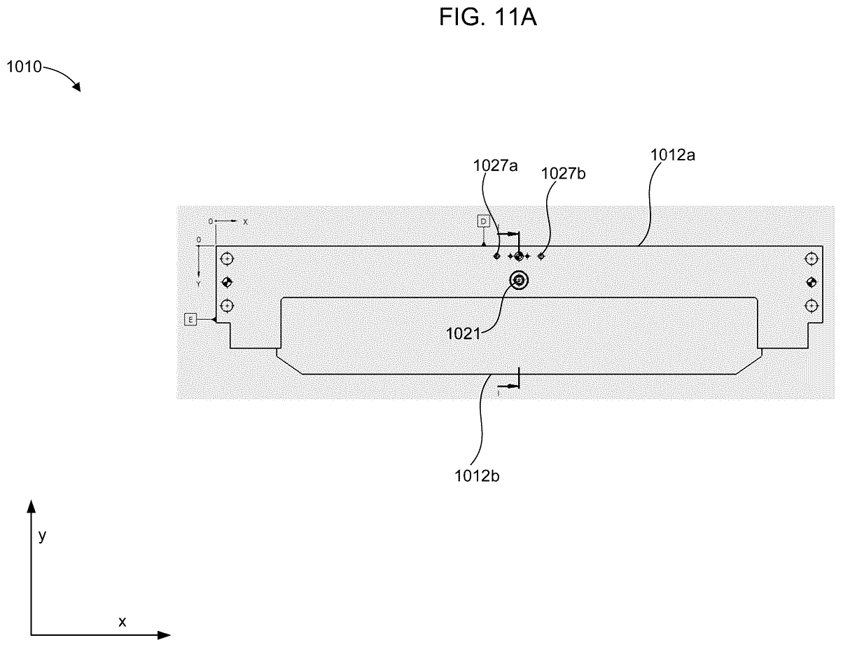

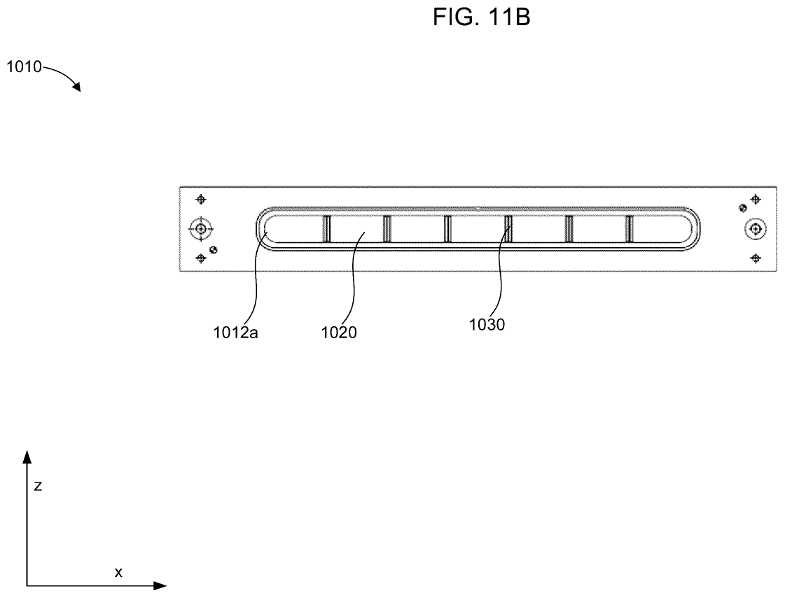

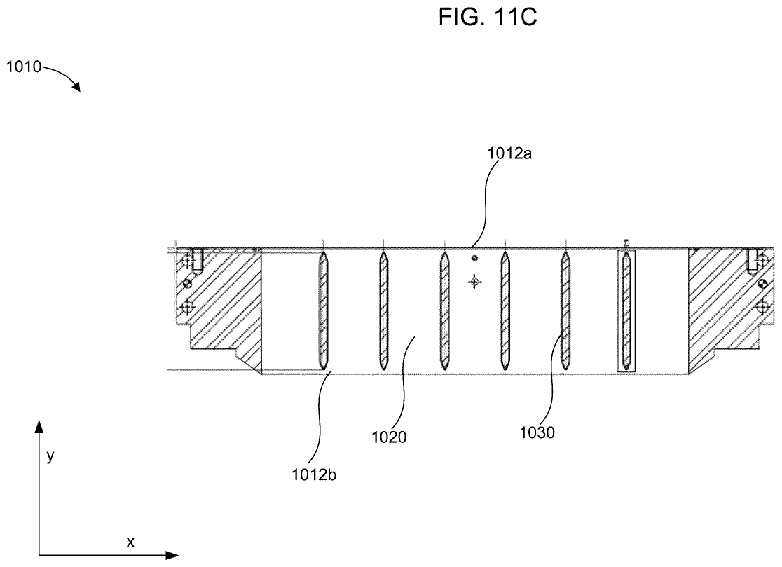

FIGS. 11A-11C are illustrations of a ribbed nozzle 1010, according to an embodiment. As shown, the nozzle 1010 includes a proximal orifice 1012a, a distal orifice 1012b, a void volume 1020, a pressure transducer holes 1021, an air vent port 1023, mounting holes 1027a, 1027b and ribs 1030. In some embodiments, the nozzle 1010, the proximal orifice 1012a, the distal orifice 1012b, the void volume 1020, and the ribs 1030 can be the same or substantially similar to the nozzle 310, the proximal orifice 312a, the distal orifice 312b, the void volume 320, and the ribs 330, as described above with reference to FIGS. 4A-4B. Thus, certain aspects of the nozzle 1010, the proximal orifice 1012a, the distal orifice 1012b, the void volume 1020, and the ribs 1030 are not described in greater detail herein. FIG. 11A shows an outside view of the nozzle 1010, FIG. 11B shows an overhead view of the nozzle 1010, FIG. 11C shows a cross section view of the nozzle 1010 looking toward the front of the nozzle 1010.

As shown, the pressure transducer hole 1021 provides a space where the pressure inside the nozzle can be measured. One or more sensors can be placed in the pressure transducer holes 1021 and/or the air vent port 1023. The air vent port 1023 releases trapped air in between consecutively loaded slurry cartridges. Also, internal vacuum pressure can be released while the piston is retracted prior to a cartridge change. The mounting holes 1027a, 1027b allow for mounting of a vent air cylinder.

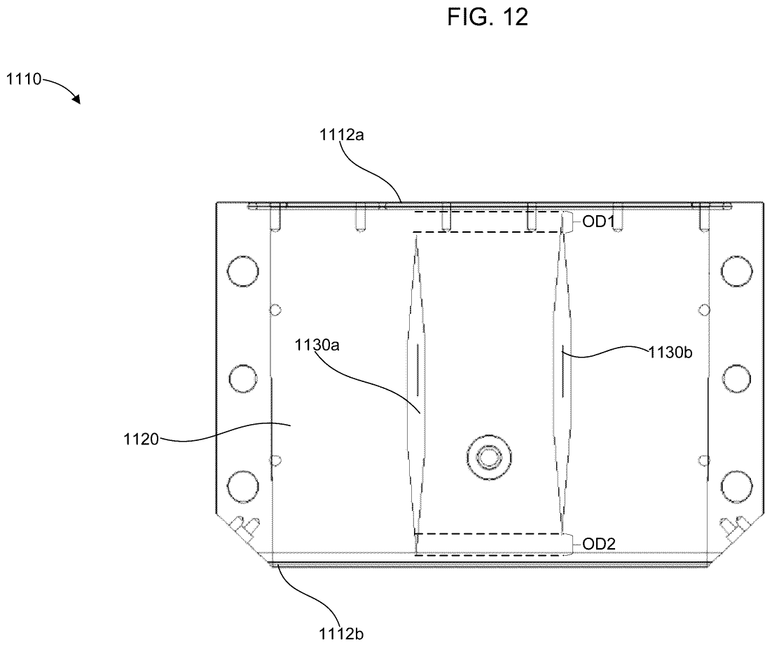

FIG. 12 is an illustration of a ribbed nozzle 1110, according to an embodiment. As shown, the nozzle 1110 includes a proximal orifice 1112a, a distal orifice 1112b, a void volume 1120, and ribs 1130a, 1130b (collectively referred to as ribs 1130). In some embodiments, the nozzle 1110, the proximal orifice 1112a, the distal orifice 1112b, the void volume 1120, and the ribs 1130 can be the same or substantially similar to the nozzle 1010, the proximal orifice 1012a, the distal orifice 1012b, the void volume 1020, and the ribs 1030, as described above with reference to FIGS. 11A-11C. Thus, certain aspects of the nozzle 1110, the proximal orifice 1112a, the distal orifice 1112b, the void volume 1120, and the ribs 1130 are not described in greater detail herein.

As shown, the rib 1130a is further advanced toward the distal orifice 1112b than the rib 1130b. Near the proximal orifice 1112a, the proximal end of the rib 1130a is offset from the proximal end of the rib 1130b by an offset distance OD1. Near the distal orifice 1112b, the distal end of the rib 1130a is offset from distal end of the rib 1130b by an offset distance OD2. In some embodiments, the offset distance OD1 can be the same or substantially similar to the offset distance OD2. In some embodiments, the offset distance OD1 can be different from the offset distance OD2.

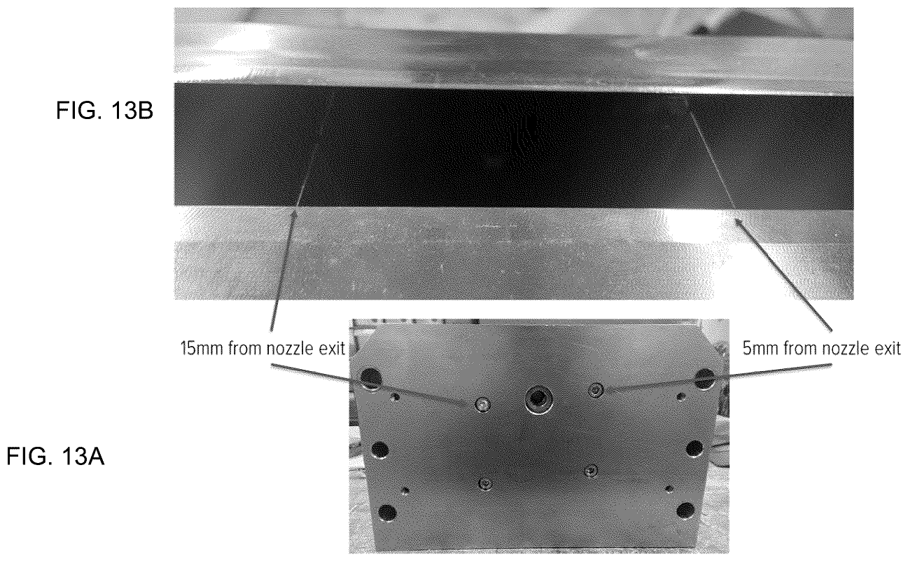

FIGS. 13A-13B are photographs of a nozzle for dispensing semi-solid electrode material. FIG. 13A shows a front view of the nozzle, while FIG. 13B shows a view of the distal end of the nozzle. As shown, the distal tip of the nozzle on the right side is set back 5 mm from the distal end of the nozzle while the distal tip of the nozzle on the left side is set back 15 mm from the distal end of the nozzle. The positioning of the rib location relative to the exit of the nozzle is a refinement parameter to maximize mechanical support and allow enough distance for the slurry to recombine. The ribs facilitated improved suck-back conditions, as the nozzle slurry cannot freely move past the rib features. The ribs facilitated other improvements to processing conditions compared to non-ribbed nozzles.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method, comprising:
dispensing an entry stream of semi-solid electrode material into a nozzle;
while the entry stream is in the nozzle, dividing the entry stream into a first substream and a second substream;
while the first substream and the second substream are in the nozzle, rejoining the first substream and the second substream to form a rejoined stream;
dispensing the rejoined stream out of the nozzle onto a current collector via an orifice to form an electrode ribbon.

2. The method of claim 1, wherein the dividing is via a rib disposed along an interior surface of the nozzle.

3. The method of claim 2, wherein the rib contacts at least two opposing inner walls of the nozzle.

4. The method of claim 3, wherein the rib has a proximal terminal end having a first width, a distal terminal end having a second width, and a central section having a third width, the third width larger than the first width and the second width.

5. The method of claim 1, wherein the dividing includes dividing the entry stream into the first substream, the second substream, and a third substream.

6. The method of claim 5, wherein the dividing is via a first rib, and a second rib spaced apart from the first rib, the first and second ribs disposed along an interior surface of the nozzle.

7. The method of claim 6, wherein each of the first rib and the second rib contact at least two interior surfaces of the nozzles.

8. The method of claim 7, wherein the second rib has a distal end, the distal end of the second rib located proximal to a distal end of the first rib.

9. The method of claim 7, wherein the second rib has a distal end, the distal end of the second rib located in line with the distal end of the first rib.

10. An apparatus, comprising:
a nozzle having a void volume, the void volume having a substantially rectangular cross section and a plurality of inner walls; and
a rib disposed in the void volume and contacting at least two inner walls of the plurality of inner walls, the rib having a proximal terminal end having a first width, a distal terminal end having a second width, and a central section having a third width, the third width larger than the first width or the second width.

11. The apparatus of claim 10, wherein the rib is a first rib, the apparatus further comprising:
a second rib disposed in the void volume and contacting at least two inner walls of the plurality of inner walls.

12. The apparatus of claim 11, wherein the second rib has a distal end, the distal end of the second rib located proximal to the distal end of the first rib.

13. The apparatus of claim 12, wherein the distal end of the second rib is proximal to the distal end of the first rib by a distance of between about 3 mm and about 3 cm.

14. The apparatus of claim 11, wherein the second rib has a distal end, the distal end of the second rib located in line with the distal end of the first rib.

15. The apparatus of claim 11, wherein the first rib is separated from the second rib by a distance of between about 2 mm and about 4 cm.

16. The apparatus of claim 10, wherein the rib includes a proximal section with a pointed end and a distal section with a pointed end.

17. An apparatus, comprising:
a nozzle including a void volume, the void volume defining:
a plenum portion configured to receive a first flow of a semi-solid electrode material,
a splitting portion downstream of the plenum portion, the splitting portion including a plurality of ribs coupled to at least two inner surface of the nozzle to define a plurality of channels configured to divide the first flow into a plurality of second flows,
a combining portion downstream of the splitting portion, the combining portion configured to combine the plurality of second flows to generate a third flow of the semi-solid material, and
a distal orifice downstream of the combining portion, the distal orifice configured to dispense the third flow,
wherein the splitting portion is configured to inhibit deflection of the nozzle during flow of the semi-solid electrode material through the void volume.

18. The apparatus of claim 17, wherein each of the plurality of the ribs have a proximal section having a proximal tip, a distal section having a distal tip, and a central section having a rectangular cross-section.

19. The apparatus of claim 18, wherein the central section is coupled to the at least two inner surfaces of the nozzle.

20. The apparatus of claim 18, wherein at least one of the proximal section or the distal section is tapered.

21. The apparatus of claim 18, wherein the plurality of ribs include a first rib and a second rib, the first rib being offset from the second rib such that a distance from a distal tip of the first rib to the distal orifice is greater than a distance from a distal tip of the second rib to the distal orifice.

22. The apparatus of claim 21, wherein a proximal tip of the first rib is offset from a proximal tip of the second rib by a first offset distance, and the distal tip of the first rib is offset from the distal tip of the second rib by a second offset distance, the second offset distance different from the first offset distance.

23. The apparatus of claim 17, further comprising:
a blade disposed downstream of the outlet, the blade angled relative to a flow axis of the nozzle.

24. The apparatus of claim 17, wherein:
a pressure transducer hole is defined in the plenum portion, and
the apparatus further comprises a pressure transducer disposed in the pressure transducer hole, the pressure transducer configured to measure a pressure of the semi-solid electrode material upstream of the splitting portion.

25. The apparatus of claim 17, wherein at least one air vent hole is defined in the plenum portion, the at least one air vent hole configured to release trapped air from the plenum portion.
